(19) United States
(12) Patent Application Publication
(10) Pub. No.: US 2018/0327041 A1
(43) Pub. Date: Nov. 15, 2018

(54) CASE HOLDER DEVICE FOR MOTORCYCLES

(71) Applicant: Quadro Vehicles S.A., Vacallo (CH)

(72) Inventors: Marco Moroni, Marnate (IT); Edoardo Giacomo Panziera, Origlio (CH); Riccardo Marabese, Gallarate (IT)

(73) Assignee: Quadro Vehicles S.A., Vacallo (CH)

(21) Appl. No.: 15/774,913

(22) PCT Filed: Nov. 11, 2016
(86) PCT No.: PCT/EP2016/077430

§ 371 Date: May 9, 2018

(30) Foreign Application Priority Data
Nov. 12, 2015 (IT) 102015000071855

(51) Int. Cl. B62J 7/04; B62J 9/00

(52) U.S. Cl. CPC B62J 7/04; B62J 9/001

(57) ABSTRACT

A case/luggage holder device (10) for the support and engagement/release of suitcases (100) and/or trunks to/from a motorcycle (300) wherein the device (10) is movable between a first position in which said suitcases (100) or trunks are positioned so as to protrude rearwardly from the motorcycle (300), and a second position in which said suitcases (100) or trunks are positioned within the outline of the motorcycle (300), above the rear portion of the motorcycle frame.

### CROSS REFERENCE TO RELATED APPLICATION(S)

The present application claims priority to PCT International Application No. PCT/EP2016/077430 filed on Nov. 11, 2016, which application claims priority to Italian Patent Application No. 102015000071855 filed Nov. 12, 2015, the entirety of the disclosures of which are expressly incorporated herein by reference.

### STATEMENT RE: FEDERALLY SPONSORED RESEARCH/DEVELOPMENT

Not Applicable.

### FIELD OF THE INVENTION

The present invention relates to a case and/or luggage holder device for motorcycles, for the support and engagement and release of baggage and/or baggage accessories such as suitcases, trunks and/or components and/or similar accessories.

The object of the present invention is also a motorcycle, in particular a motorcycle which comprises said case and/or baggage holder device of the aforesaid type.

### BACKGROUND ART

The use is known in the field of motorcycles, of accessories such as suitcases or travel bags and trunks, which are adapted both to be transported by hand and also to be fastened, in particular removably engaged, to the motorcycle by means of systems which precisely allow the quick engagement, and just as quick, a release thereof.

Such systems or case and/or trunk and/or bag holder devices of known type substantially may be divided into two groups.

A first group comprises devices provided with a support frame which is fastened to the motorcycle, usually in the rear area, in particular laterally with respect to the back end (rear axle) and therefore to the saddle of the vehicle, and allows the engagement of suitcases which therefore, once secured, are transported so as to protrude laterally with respect to the vehicle, hunging on the support frame.

A second group comprises devices provided with a support plate which is fastened to the motorcycle, also in this case in the rear area of the back end (rear axle), but here in the rear position (behind) with respect to the saddle, and is generally intended to protrudingly support a trunk, that is one suitcase alone having such shape and dimensions so as to be arranged resting on the plate. Essentially, while the accessories such as suitcases and/or trunks are “hung”on the device in the case of devices of the first type, the aforesaid accessories are rested on the support plate and secured thereto in the case of devices of the second type, wherein in this second case the lateral volume or bulk is avoided which is typical of suitcases transported by means of devices of the first type. However, in the case of devices of the second type, the driver inevitably perceives a worsening of the driving conditions of the vehicle as a result of the mass of the load or baggage (trunk and/or suitcase) transported and protrudingly secured and in remote position from the center (of gravity) of the motorcycle.

It is indeed a commonly perceived experience for a trunk to worsen the driving feeling in particular in turns, both entering and driving through the turn, under conditions of tilted vehicle.

Moreover, although generally the devices of the second group or type are for the most part intended to be used on scooters and motorcycles used in the city (with reduced and not “sports” performance), it is not at all infrequent the use of devices of the second type also on large cylinder motorcycles with high performances, and even on sports motorcycles, to transport suitcases and/or trunks in the rear protruding position wherein, in the case of motorcycles of this type, the worsening perception of the driving conditions is even more significant, in particular due to the reduced weight of the motorcycles and the driving position.

Further examples of case holder devices for motorcycles according to the prior art are known from prior art documents DE 102013223317, JP 2014213733, DE 102006046005, US 2013/134747 and US 2013/284782.

### SUMMARY OF THE INVENTION

It is therefore the main object of the present invention to overcome or at least minimize the drawbacks and/or disadvantages encountered in the devices according to the prior art and summarized above.

In particular, a first object of the present invention is to make available a case holder device which is both adapted to be applied (fastened) to a motorcycle and which allows both the side volume (and the uneven or asymmetrical distribution of the load, in the case of suitcases and/or trunks applied only on one side of the motorcycle) and the perception of worsening of the guide conditions due to the loads transported protruding rearwardly, to be avoided, especially in absence of a passenger.

It is also an object of the present invention to make available a device of the aforesaid type which allows the user to engage and release one or more suitcases and/or one or more trunks in a simple and quick manner, and which simultaneously allows distributing and/or positioning the load symmetrically (with respect to the longitudinal symmetry plane of the motorcycle), substantially as in the case of traditional devices of the second type, but which also allows varying the position of the load according to the presence or absence of a passenger.

It is a further object of the present invention to also make available a support device which can be switched between at least two positions and by means of which, with the device in one position, the load or baggage is positioned within the outline of the motorcycle (according to a top view), with significant advantages in terms of substantially unaltered driving conditions but also for example during the step of parking, while with the device in the second position, the load or baggage is (possibly) positioned outside the outline, but the device itself performs the functions of support element (practically of backrest) for a passenger.

Within the scope of the above disclosure, it is a further object of the present invention to provide a case holder device for the support and engagement and release of suitcases and/or trunks to/from a motorcycle which, with the suitcases and/or trunks positioned within the outline of the motorcycle, allows said suitcases and/or trunks to be positioned behind the driver, substantially at and on the passenger seat, so as to move the mass transported close to the center of the vehicle, thus improving the driving conditions because the mass of the suitcases and/or trunks is precisely conducted to the position of the passenger.

It is a further object of the present invention to provide a case and/or trunk and/or baggage holder device in general for motorcycles, which allows reducing the overall volume or bulk of the vehicle, thus in particular reducing the longitudinal volume or bulk and promoting the possibility of parking, as indicated above. It is indeed known that parking spaces for motorcycles are generally delimited by spaces arranged parallel to one another and having longitudinal dimensions which are comparable to the average longitudinal volume or bulk of a motorcycle. When the motorcycle is equipped with a known protruding trunk, and such a trunk protrudes from the outline of the vehicle, even by 50 cm or more, this results in the parked vehicle not respecting the volume or bulk dimensions provided by the parking space.

The larger volume may also be dangerous even if the vehicle is parked stably on the middle kickstand, when present, because it is at risk of involuntary blows for example by other vehicles in transit when the parking space is provided on the side of the roadway.

The present invention is based on the consideration according to which the drawbacks detected in known devices may be overcome or at least effectively reduced by means of a device which allows the positioning of the load (one or more suitcases and/or one or more trunks) in at least two different positions according to whether or not a passenger is present, wherein, in the absence of the passenger, the load may be positioned substantially at and on the portion of saddle intended for the passenger, while in the presence of the passenger, the load may be positioned so as to protrude in longitudinal direction and rearwardly with respect to the motorcycle.

On the basis of the above considerations and taking into account the drawbacks and/or disadvantages detected in the devices according to the prior art, according to the present invention, there is provided a case holder device for the support and engagement/release of suitcases and/or trunks to/from a motorcycle, comprising a fastening structure to the vehicle, support means of said suitcase or trunk, wherein said support means of said suitcase or trunk are movable with respect to said fastening structure, the device further comprising the additional features as recited in claim 1.

In the device according to the present invention, said support means are movable between a first position in which said suitcases or trunks are positioned so as to protrude rearwardly from the vehicle, and a second position in which said suitcases or trunks are positioned within the outline of the vehicle, on the rear portion of the vehicle frame.

In the case holder device according to the present invention, said support means are rotatable with respect to said fastening structure and the device may possibly further comprise guide means of the rotation of said support means.

The device may possibly further comprise at least one base body configured so as to be substantially horizontal when the device is installed on the motorcycle, and supporting guide means of the rotation of said support means defining an axis of rotation A for the rotation of said support means.

In the above device, said guide means may possibly comprise a body which longitudinal axis is substantially perpendicular to said base body of said fastening structure to the vehicle, and form (define) the axis of rotation of said support means.

The device may also further comprise locking means which are adapted to be operated by the user, said locking means being adapted to selectively lock the rotation of said support means, said locking means possibly comprising at least one locking pin and at least one first seat formed on the outer surface of said body, adapted to receive said locking pin.

According to an embodiment of the device, said locking means further comprise a second seat adapted to receive said locking pin and formed on the outer surface of said cylindrical body in a diametrically opposite position with respect to said first seat.

Again according to an embodiment, the device may further comprise a lever which is operable by the user for the manual operation of said locking means, for example hinged at a hinge to a portion of said support means and connected to said locking pin so that the rotation of said lever about the hinge away from the body takes place by counteracting the action of one or more return springs acting between the body and said lever so as to pull said lever towards the body.

According to further embodiments, the device may further comprise, associated with said lever, a support element which allows supporting the back of a passenger seating on the vehicle.

Again on the basis of the above considerations and taking into account the drawbacks and/or disadvantages detected in the devices according to the prior art, according to one embodiment, the present invention relates to a case holder and/or luggage holder device for motorcycles, said device comprising a fastening structure for fastening said device to a motorcycle, and support means for the support of at least one luggage trunk and/or at least one suitcase, wherein said support means are rotatable with respect to said fastening structure about an axis of rotation A between a first position in which said support means (and said at least one trunk and/or said at least one suitcase) are positioned so as to protrude rearwardly with respect to the motorcycle and at least partly outside of the outline of the motorcycle, and a second position in which said support means (and said at least one trunk and/or said at least one suitcase) are positioned within the outline of the motorcycle, on the rear portion of the frame of the motorcycle.

According to one embodiment, in said second position, said support means (and said at least one trunk and/or said at least one suitcase) are positioned within the outline of the motorcycle, on the rear portion of the saddle of the motorcycle reserved for the passenger.

According to one embodiment, said fastening structure comprises a rotation element or pin, wherein said support means are fastened to said rotation element or pin and are rotatable with respect to said rotation element or pin between said first position and second position.

According to one embodiment, said rotation element or pin comprises at least one cylindrical portion, wherein the axis of rotation A of said support means coincides with the longitudinal symmetry axis of said at least one cylindrical portion of said rotation element or pin.

According to one embodiment, said fastening structure comprises adjustment means for adjusting the orientation of the axis of rotation of said support means.

According to one embodiment, said adjustment means are configured so as to allow the orientation of the axis of rotation A of said support means so that said axis of rotation A substantially lies on the longitudinal symmetry plane of said motorcycle, in particular the substantially vertical orientation of said axis of rotation A with said motorcycle under still or stopped condition.

According to one embodiment, said device further comprises locking means which are operable (switchable) by the user and are adapted to selectively lock said support means in said first position and second position.

According to one embodiment, said locking means comprise at least one first engaging seat and a second engaging seat formed on the outer surface of said rotation element or pin, and at least one movable locking pin adapted to selectively engage said first locking seat and second locking seat and to be selectively disengaged from said first locking seat and second locking seat.

According to one embodiment, said device further comprises a lever which is operable by the user for the manual operation of said locking pin.

According to one embodiment, said lever is rotatably constrained to a portion of said support means and is connected to said locking pin so that the rotation of said lever in two opposite directions of rotation results in the disengagement of said locking pin from said engagement seats and the engagement of said engagement seats by said locking pin, respectively.

According to one embodiment, said locking means comprise elastic return means, wherein the rotation of said lever in a first direction of rotation aiming to disengage said locking pin from said engagement seats occurs against the resistance exerted by said return means, while the rotation of said lever in the opposite direction of rotation is facilitated by the elastic return action exerted by said return means.

According to one embodiment, said device further comprises, associated with said lever, a support element which, with said support means in said second position, allows supporting the back of a passenger on board the vehicle.

According to one embodiment, said fastening structure comprises fastening means adapted to allow the fastening of a top for covering the motorcycle.

According to one embodiment, said support means comprise an arc-shaped support portion which defines a main symmetry plane, wherein said arc-shaped portion is adapted to support at least one trunk or one suitcase on each of the two opposite sides with respect to said main symmetry plane.

The present invention further relates to a motorcycle comprising a device according to any one of the embodiments as summarized above.

Further possible embodiments of the device according to the present invention are defined in the claims.

A description will be given below, by way of non-limiting examples, of the embodiments of the device according to the present invention which are depicted in the drawings, wherein therefore the present invention is not limited to the embodiments depicted in the drawings.

The device according to the present invention is particularly advantageously applied in the case of the so-called “city” motorcycle such as scooters or the like, this in particular being the reason why the device according to the present invention is described below with particular reference to its applications to motorcycles of the aforesaid type. The possible applications of the device according to the present invention in any case comprise motorcycles of any type.

### BRIEF DESCRIPTION OF THE DRAWINGS

In the drawings:

FIG. 1 shows a side view of a motorcycle equipped with a case holder device according to an embodiment of the present invention in a first position, in which said suitcases and/or trunks are positioned so as to protrude rearwardly from the vehicle;

FIG. 2 shows a side view of a motorcycle equipped with a case holder device according to an embodiment of the present invention in a second position, in which said suitcases or trunks are positioned within the outline of the vehicle, above the rear portion of the vehicle frame;

FIG. 3 shows a perspective assembly view of the case holder device according to an embodiment of the present invention, configured to support two suitcases (or to trunks) arranged side-by-side;

FIG. 4 shows a perspective assembly view of the case holder device according to an embodiment of the present invention, configured to support one trunk alone;

FIG. 5 shows a perspective and partial sectional view according to a vertical plane of the device according to the configuration in FIG. 3;

FIG. 6 shows a partial sectional side view according to a vertical plane of the device according to FIG. 5, in a configuration in which the device is locked;

FIG. 7 shows the same side view in FIG. 6, in a configuration in which the device is released;

FIG. 8 shows a detail of the movement means of the case holder device according to an embodiment of the present invention;

FIG. 9 shows one of the components of the movement means of the case holder device according to an embodiment of the present invention, in greater detail;

FIG. 10 shows the same side view of a motorcycle equipped with the case holder device according to the embodiment of the present invention in FIG. 1, in which one suitcase alone is associated with the device and in which the device supports an accessory, in particular a top;

FIG. 11 shows the same side view of a motorcycle equipped with the case holder device according to the embodiment of the present invention in FIG. 2, in which one suitcase alone is associated with the device and in which the device supports an accessory, in particular a top.

### DETAILED DESCRIPTION OF THE INVENTION

According to a preferred embodiment of the present invention illustrated in the mentioned drawings by way of a non-limiting example, the baggage holder device 10, in particular suitcase and/or trunk bolder device according to the present invention, for the support and engagement/release of suitcases 100 and/or trunks 200 and adapted to be fastened to a motorcycle 300, comprises a fastening structure to the vehicle 11, support means 12 of said suitcases 100 and/or trunks 200 constrained to said support structure 11 in a rotatable manner.

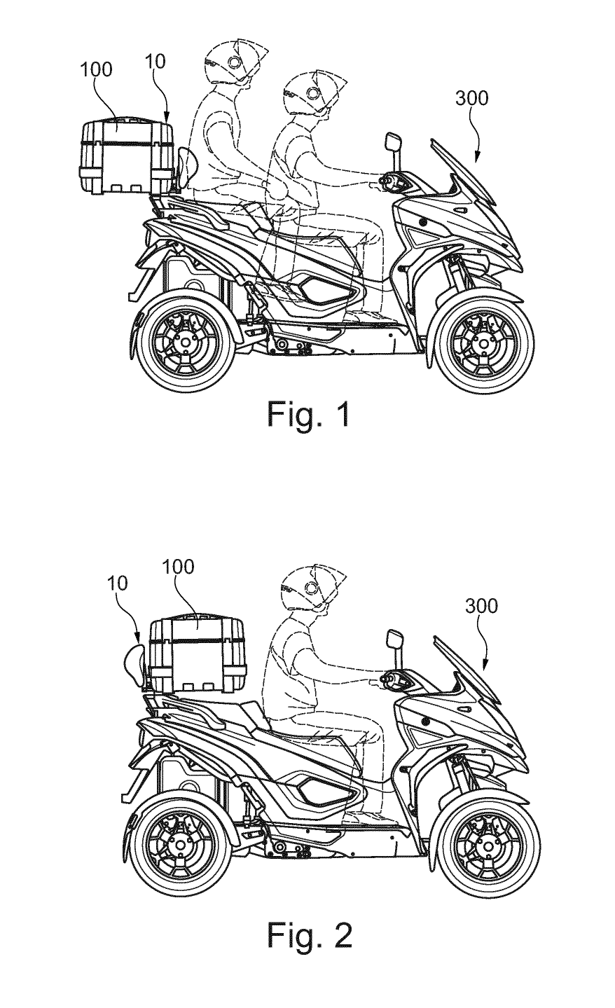

In greater detail, the device 10 according to the embodiment of the present invention depicted in the drawings is configured so that when said fastening structure 11 is connected to the vehicle, said support means 12 of said suitcase 100 or trunk 200 are rotatable with respect to said fastening structure 11 (and therefore with respect to the motorcycle 300) between a first position (depicted in FIG. 1) in which said suitcases 100 and/or trunks 200 are positioned so as to protrude in longitudinal direction and in particular, rearwardly from vehicle 300, and a second position (depicted in FIG. 2) in which said suitcases 100 and/or trunks 200 are positioned within the outline of vehicle 300 (in longitudinal direction), above the rear portion of the vehicle frame, in particular at and on the portion of saddle dedicated to the passenger.

As clearly arising from the observation of FIGS. 1 and 2, the device 10 according to the present invention allows being rotated between two positions, and therefore the suitcases 100 and/or trunks 200 attached thereto to be positioned in two corresponding positions, wherein in one position (FIG. 1) the normal use of the motorcycle is allowed with the transportation of the passenger (when this is required), while in the other position (FIG. 2), the load is positioned within the outline of vehicle 300 (at least in longitudinal direction), in particular above the rear portion of the vehicle where the portion of saddle intended for the passenger is positioned.

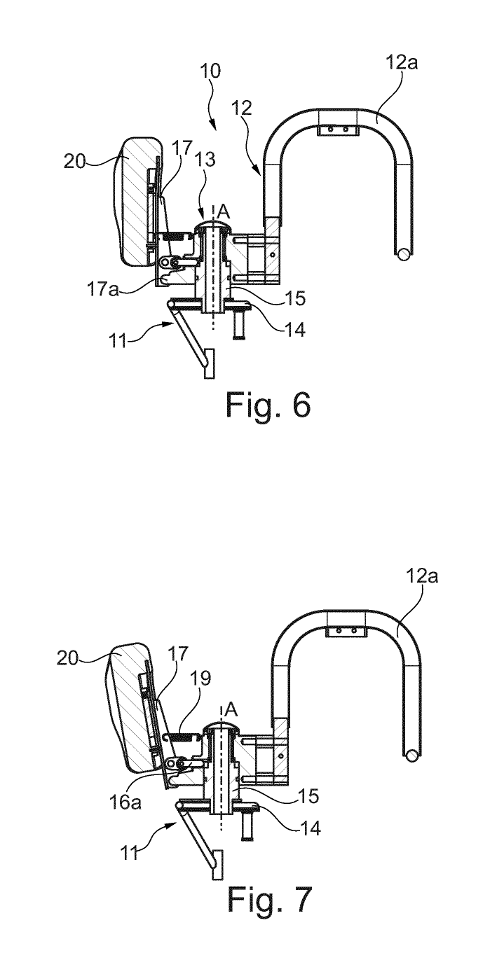

It also arises from FIGS. 1 and 2 how, in the case of the embodiment therein depicted, the support means 12 (and therefore the suitcases 100 and/or trunks 200) are rotatable about a substantially vertical axis; to this end, it is worth noting how the fastening structure 11 comprises adjustment means (not depicted) adapted to allow the adjustment of the orientation of the axis of rotation (identified by letter A in FIGS. 6 and 7) of the support means 12, and therefore to position the axis of rotation A according to the needs and/or circumstances, in particular to the motorcycle type, on the longitudinal symmetry plane and oriented vertically, at least with motorcycle 300 under still or stopped condition. It is also worth noting that the definition of longitudinal symmetry plane of the motorcycle means the longitudinal symmetry plane of the symmetrical parts of the motorcycle itself, such as for example the tank, the rear wheel, the saddle and/or the main fairing.

In order to obtain the above results, in particular the rotation of the support means 12 and the positioning thereof in the aforesaid two positions, the device 10 according to the embodiment of the present invention advantageously comprises guide means 13 of the rotation of said support means 12.

Said guide means 13 of the rotation of said support means 12 are in particular configured to allow the movement of said support means 12, thus allowing the rotation thereof about a vertical axis of rotation A.

For this purpose, said rotation guide means 13 comprise at least one body or element 15 with at least one cylindrical portion which longitudinal symmetry axis coincides with the axis of rotation of said support means of said suitcase or trunk, said support means 12 being rotatably associated with (engaged on said cylindrical portion of) said body 15 by means of a system of bearings (in themselves known and therefore not described in detail) in order to sustain the axial thrust and to allow the rotation about axis A identified by said rotation guide element 15.

More specifically, said fastening structure 11 to the vehicle comprises a base body 14 configured so as to be substantially horizontal with respect to the ground when the device is installed on the motorcycle (and the motorcycle is not running), and said support means 12 are rotatably associated with said guide means 13, thus being rotatable with respect to said guide means 13.

According to the embodiment depicted by way of example in the accompanying figures, the longitudinal axis of the cylindrical portion of body 15 is substantially perpendicular to said base body 14 of said fastening structure 11 to the vehicle and precisely coincides with the axis of rotation of said support means 12.

According to the embodiment of the present invention depicted by way of a non-limiting example in the accompanying drawings, the device 10 according to the present invention further comprises locking means 16 operable by the user, which are adapted to selectively lock the rotation of said support means 12, in particular to selectively lock the support means 12 in the aforesaid two positions.

Preferably, said cylindrical body 15 comprises a base rigidly fixed to the fastening structure 10 and from which the aforesaid cylindrical portion extends, and said locking means 16 comprise at least one locking pin 16a and at least a first engagement seat 15a formed on the outer surface of said base of said body 15.

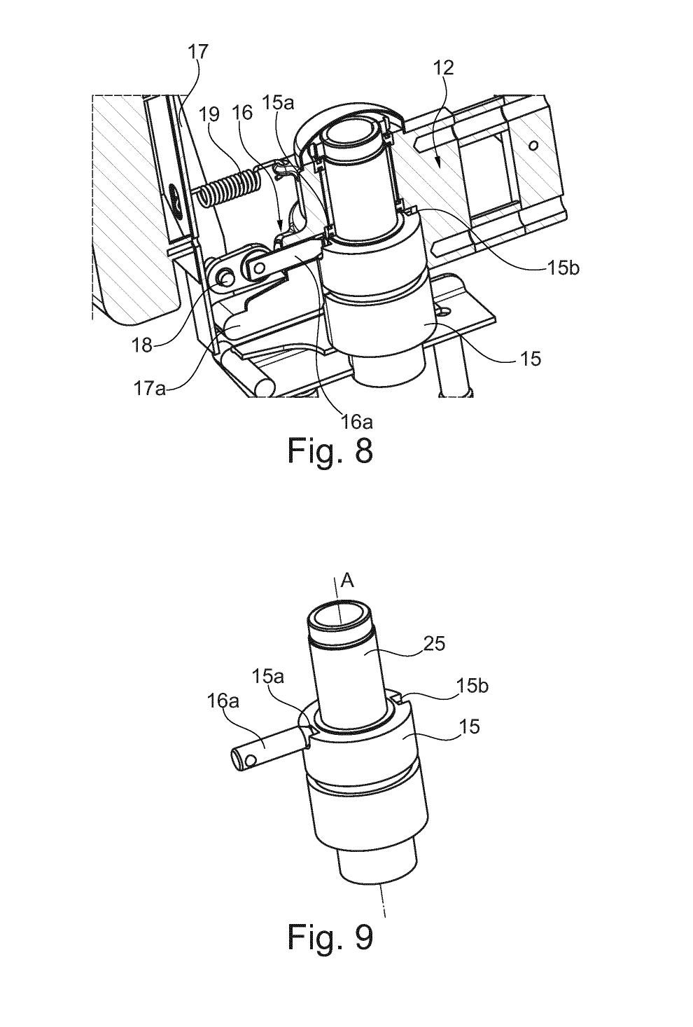

Said at least one locking pin 16a in particular is movable (switchable) between a locked position (depicted in FIGS. 6 and 8), in which said locking pin 16a precisely engages the corresponding seat 15a formed on said body 15, and a released position (depicted in FIG. 7), in which, said locking pin 16a is disengaged from said seat 15a, so that said support means 12 are free to rotate about the axis of rotation A.

Advantageously, said locking means further comprise a second seat 15b adapted to be engaged by said locking pin 16a and formed on the outer surface of said body 15 in a diametrically opposite position with respect to said first seat 15a.

Now to describe in greater detail the operation of device 10 according to the embodiment of the present invention depicted in the figures, it is worth first noting the condition in FIG. 6 in which said support means 12 are locked, with respect to the rotation, by the engagement of pin 16a with said first seat 15a.

Starting from the aforesaid locked condition, the user may manually act on said locking means, in particular on said pin 16a, thus causing its disengagement from said first seat 15a, and therefore releasing the support means 12 from pin 15, in particular making them rotatable with respect to pin 15. At this point, the support means 12 may be manually rotated about the axis of rotation A identified by the body 15, up to said aforesaid second position in which said pin 16a is positioned at the second seat 15b, in which it may be engaged, thus locking the support means 12 in the new second position, which is diametrically opposite to the first position.

With reference to the accompanying drawings, in particular to FIGS. 6 and 7, according to one embodiment of the present invention, said locking means 16 are operable by the user by means of a lever 17.

Preferably, said lever 17 is rotatably hinged by means of a hinge 17a to a portion of said support means 12, and therefore rotates therewith during the rotation of the means 12 about pin 15 according to the methods described above, and the rotation of said lever 17 about said hinge 17a in a first direction of rotation, in particular away from the support means 12, takes place by counteracting the action of elastic return means (for example, as depicted, one or more helical return springs 19) and results in a translation of pin 16a in a first translation direction of disengagement from the corresponding engagement seat (15a or 15b, according to the actual position of the support means 12). Then, with pin 16a being disengaged from the engagement seat 15a or 15b, the support means 12 may be rotated on pin 15 up to positioning the pin or latch 16a at the seat which is diametrically opposite to the seat from which it was released, wherein it is pulled (together with lever 17) by the elastic return means 19, thus precisely engaging the new engagement seat.

Said locking pin 16a of said locking means 16 is also connected on said lever 17, also in this case with a connection which comprises a hinge.

More specifically, according to that shown in FIGS. 6 and 7, lever 17 is hinged at hinge 17a arranged at an end of said lever 17, wherein said return spring 19 is connected to a point of said lever 17 which is far from said constraining and/or hinging end of said lever 17, and said locking pin 16a is connected to said lever 17 at an intermediate point between said hinge 17a and said spring 19.

Due to this configuration, the user may grip the free end of lever 17, which is opposite to the end hinged at 17a, and pulling outwardly, that is in the direction moving away from the axis of rotation A, opposing the force exerted by the return spring 19, may release pin 16a from said first seat 15a.

The possibility also remains of using torsion springs which can be positioned on the axis of hinge 17a, and/or compressions springs which can be positioned between lever 17 and body 15 in the part below the axis of hinge 17a.

At this point, as indicated above, the user may manually accompany the support means 12 in the rotation thereof on pin 15 about axis A up to bringing said locking pin 16a at the second seat 15b, which is diametrically opposite to the first seat 15a, thus performing a rotation of the support means 12 themselves.

Once the rotation of the support means 12 is complete, the locking pin autonomously engages the second seat 15b because, as indicated above, lever 17, and accordingly the locking pin, are pulled by the return spring 19. Therefore, the automatic locking of the support means 12 is achieved when the rotated position is achieved with respect to the starting position.

Naturally, with an identical procedure the user may rotate the support means 12 again, thus returning them to the initial position in which the locking pin 16a is inserted into the first seat 15a.

The device 10 according to the present invention therefore rather easily allows the user to rotate the support means 12 between a first position (depicted in FIG. 1) in which said suitcases 100 and/or trunks 200 are positioned so as to protrude in longitudinal direction and rearwardly from vehicle 300, and a second position (depicted in FIG. 2) in which said suitcases 100 and/or trunks 200 are positioned within the outline of vehicle 300, at least in longitudinal direction, and above the rear portion of the vehicle frame, in particular where the portion of saddle dedicated to the passenger is located.

Advantageously, as depicted in particular in the assembly views in FIGS. 1 and 2, and in greater detail in FIGS. 6 and 7, a support element 20 (essentially a backrest) may be associated with said lever 17 which allows the passenger's back to be supported when the device is used in the configuration of FIG. 1, in which said suitcases 100 or trunk 200 are positioned so as to protrude rearwardly from vehicle 300. Preferably, such a support element 20 consists of an ergonomically shaped element so as to improve the comfort for the passenger, even more preferably it may be made of material soft to the touch and/or adequately padded.

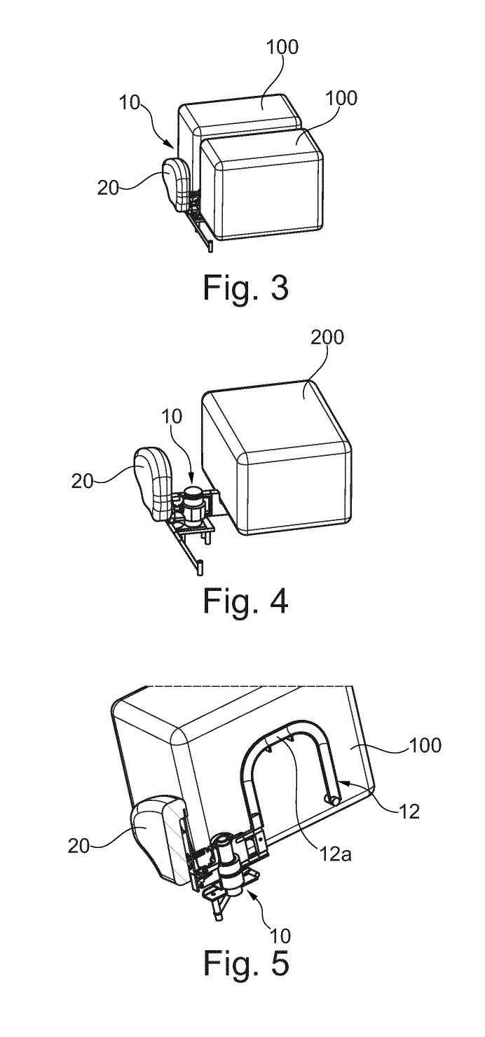

According to the preferred embodiment of the present invention shown by way of a non-limiting example in the accompanying drawings, the support means 12 comprise a support bar 12a, which essentially is arc-shaped, for example having a circular or square or rectangular cross section, configured so that when said fastening structure 11 is fixed to the vehicle, said support bar 12a substantially is positioned at the centerline axis of the vehicle so as to support a first suitcase 100 constrained laterally to said support bar 12a and a second suitcase 100 again constrained laterally to said support bar 12a on the side opposite to said bar, as shown for example in FIG. 3.

Thereby, among the other advantages already resulting from the description of device 10 according to the present invention, the further results are obtained of being able to mount a pair of suitcases on a motorcycle, within the outline of the vehicle itself, which suitcases usually are mounted with known systems on the side of the vehicle itself, thus protruding laterally from the outline of the vehicle.

Therefore, in the case of a pair of travel suitcases, the advantages achievable from the device according to the present invention in terms of reducing the volumes both when the vehicle is stopped, still or moving, improved maneuverability of the means during the maneuvering steps at reduced speed, and improved driving dynamics at a faster speed, are even more appreciated.

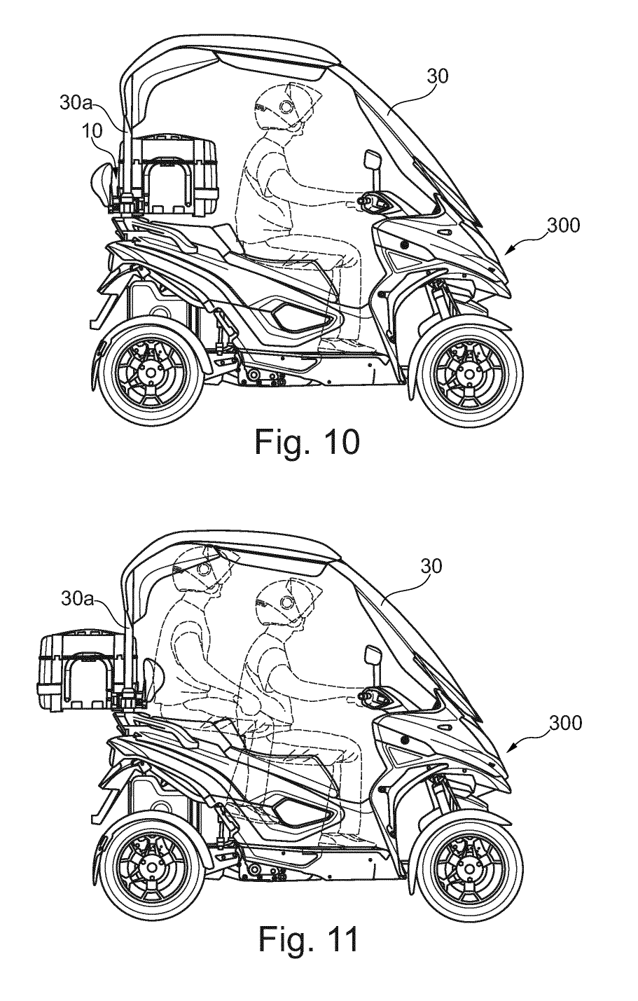

Not lastly, the device according to the present invention allows, in particular when mounted on motorcycles intended to be used in the city such as scooters and other three-or four-wheel vehicles with at least one pair of wheels on the same tilting axis, acting as a support for fastening a further accessory, that is a covering top 30 of the vehicle, as shown for example in the assembly views in FIGS. 10 and 11.

Here, the axial shaft 25 itself of the guide element 15 advantageously may act as a support.

The scope of protection of the claims is not to be limited by the disclosures or preferred embodiments shown in the description by way of example, but rather the claims should comprise all features of patentable novelty inferable from the present invention, including all features which would be treated as equivalent by the person skilled in the art.

1. A case holder and/or luggage holder device for motorcycles, said device comprising a fastening structure for fastening said device to a motorcycle, and support means for the support of at least one trunk and/or at least one suitcase, wherein said support means are rotatable with respect to said fastening structure according to an axis of rotation (A) between a first position in which said support means and said at least one trunk and/or said at least one suitcase are positioned so as to protrude rearwardly with respect to the motorcycle and at least partly outside of the outline of the motorcycle, and a second position in which said support means and said at least one trunk and/or said at least one suitcase are positioned within the outline of the motorcycle, on the rear portion of the frame of the motorcycle, wherein said fastening structure comprises a rotation element or pin, wherein said support means are fastened to said rotation element or pin and are rotatable with respect to said rotation element or pin between said first position and second position, characterized in that said fastening structure comprises adjustment means for adjusting the orientation of the axis of rotation of said support means, and in that said adjustment means are configured so as to allow the orientation of the axis of rotation (A) of said support means so that, with said device fastened to said motorcycle, said axis of rotation (A) can be oriented so as to substantially lies on the longitudinal symmetry plane of said motorcycle, in particular so that axis of rotation (A) can be oriented so as to be substantially vertical with said motorcycle under still or stopped condition.

2. The device according to claim 1, characterized in that, in said second position, with said device fastened to said motorcycle, said support means and said at least one trunk and/or said at least one suitcase are positioned within the outline of the motorcycle, on the rear portion of the saddle of the motorcycle reserved for the passenger.

3. The device according to claim 1, characterized in that said rotation element or pin comprises at least one cylindrical portion, and in that the axis of rotation (A) of said support means coincides with the longitudinal symmetry axis of said at least one cylindrical portion of said rotation element or pin.

4. The device according to claim 2, characterized in that said rotation element or pin comprises at least one cylindrical portion, and in that the axis of rotation (A) of said support means coincides with the longitudinal symmetry axis of said at least one cylindrical portion of said rotation element or pin.

5. The device according to claim 1, characterized in that it further comprises locking means operable by the user and adapted to selectively lock said support means in said first position and second position.

6. The device according to claim 4, characterized in that it further comprises locking means operable by the user and adapted to selectively lock said support means in said first position and second position.

7. A case holder device according to the preceding claim 6, characterized in that said locking means comprise at least one first locking seat and a second locking seat formed on the outer surface of said rotation element or pin and at least one movable locking pin adapted to selectively engage said first locking seat and second locking seat and to be selectively disengaged from said first locking seat and second locking seat.

8. The device according to the preceding claim 7, characterized in that it further comprises a lever operable by the user for the manual operation of said locking pin.

9. The device according to the preceding claim 8, characterized in that said lever is rotatably constrained to a portion of said support means and is connected to said locking pin so that the rotation of said lever in two opposite directions of rotation results in the disengagement of said locking pin from said engagement seats or and in the engagement of said engagement seats or by said locking pin, respectively.

10. The device according to claim 9, characterized in that said locking means comprise elastic return means, and in that the rotation of said lever in a first direction of rotation aiming to disengage said locking pin from said engagement seats or occurs against the resistance exerted by said return means, while the rotation of said lever in the opposite direction of rotation is facilitated by the elastic return action exerted by said return means.

11. The device according to claim 10, characterized in that it further comprises, associated with said lever, a support element which, with said support means in said second position, allows supporting the back of a passenger on the vehicle.

12. The device according to claim 11, characterized in that said fastening structure comprises fastening means adapted to allow the fastening of a top for covering the motorcycle.

13. The device according to claim 12, characterized in that said support means comprise an arc-shaped support portion which defines a main symmetry plane, and in that said arc-shaped portion is adapted to support at least one trunk or one suitcase on each of the two opposite sides with respect to said main symmetry plane.

14. A motorcycle comprising a device according to claim 13.
